(19) United States
(12) Patent Application Publication
(10) Pub. No.: US 2025/0292935 A1
(43) Pub. Date: Sep. 18, 2025

(54) Soft Magnetic Powder, Dust Core, Magnetic Element, And Electronic Device

(71) Applicant: SEIKO EPSON CORPORATION, Tokyo (JP)

(72) Inventor: Toshiki SANO, Hachinohe (JP)

(21) Appl. No.: 19/077,450

(22) Filed: Mar. 12, 2025

(30) Foreign Application Priority Data
Mar. 13, 2024 (JP) 2024-039184

(51) Int. Cl. H01F 3/08; B22F 1/05; B22F 1/105; C22C 38/00; C22C 38/02; C22C 38/34; H01F 1/147

(52) U.S. Cl. CPC H01F 3/08; B22F 1/05; B22F 1/105; C22C 38/002; C22C 38/008; C22C 38/02; C22C 38/34; H01F 1/14766; B22F 2301/35; B22F 2304/10; B22F 2999/00; C22C 2202/02

(57) ABSTRACT

A soft magnetic powder contains: Fe as a main component; Si having a content of 2.5 mass % or more and 7.5 mass % or less; Cr having a content of 1.0 mass % or more and 10.0 mass % or less; Sn having a content of 0.05 mass % or more and 1.10 mass % or less; and an impurity, in which a mass ratio Sn/Cr of a content amount of Sn to a content amount of Cr is 0.02 or more and 0.30 or less, an average particle diameter is 1.5 μm or more and 11.0 μm or less, and Sn-substituted hematite in which a part of Fe atoms forming hematite is substituted by Sn atoms is precipitated by a heat treatment in an air atmosphere.

The present application is based on, and claims priority from JP Application Serial Number 2024-039184, filed Mar. 13, 2024, the disclosure of which is hereby incorporated by reference herein in its entirety.

### BACKGROUND

### 1. Technical Field The present disclosure relates to a soft

magnetic powder, a dust core, a magnetic element, and an electronic device.

### 2. Related Art

JP-A-2008-124270 discloses a soft magnetic powder having a composition represented by Fe-2% Si-1% Cr-1% Sn and an average particle diameter of 55 μm or 200 μm. In the soft magnetic powder, a crystal grain diameter is optimized. Accordingly, it is possible to obtain a dust core having low core loss when excited at a predetermined excitation frequency. It is also disclosed that when the dust core is produced, an insulating coating film treatment is performed by adding a silicone resin.

JP-A-2008-124270 discloses that an insulating material such as the silicone resin is added when producing the dust core using the soft magnetic powder. The addition of the silicone resin ensures insulating properties between particles. However, the insulating material such as the silicone resin does not have sufficient insulating properties and cannot sufficiently increase a withstand voltage of the dust core. Although the withstand voltage can be increased by adding a large amount of the silicone resin, in this case, a density of the dust core (a proportion of the soft magnetic powder) decreases, and magnetic properties may decrease.

Therefore, it is a problem to obtain a soft magnetic powder with which a dust core having a high density and a high withstand voltage can be produced.

### SUMMARY

A soft magnetic powder according to an application example of the present disclosure contains:
Fe as a main component;
Si having a content of 2.5 mass % or more and 7.5 mass % or less;
Cr having a content of 1.0 mass % or more and 10.0 mass % or less;
Sn having a content of 0.05 mass % or more and 1.10 mass % or less; and
an impurity, in which
a mass ratio Sn/Cr of a content amount of Sn to a content amount of Cr is 0.02 or more and 0.30 or less,
an average particle diameter is 1.5 μm or more and 11.0 μm or less, and
Sn-substituted hematite in which a part of Fe atoms forming hematite is substituted by Sn atoms is precipitated by a heat treatment in an air atmosphere.

A dust core according to an application example of the present disclosure contains:
a soft magnetic powder
   which contains Fe as a main component,
   Si having a content of 2.5 mass % or more and 7.5 mass % or less,
   Cr having a content of 1.0 mass % or more and 10.0 mass % or less,
   Sn having a content of 0.05 mass % or more and 1.10 mass % or less, and
   an impurity,
   whose mass ratio Sn/Cr of a content amount of Sn to a content amount of Cr is 0.02 or more and 0.30 or less, and
   whose average particle diameter is 1.5 μm or more and 11.0 μm or less; and
a binding portion which is made of an Fe oxide and binds particles of the soft magnetic powder, in which
the Fe oxide contains Sn-substituted hematite in which a part of Fe atoms forming hematite is substituted by Sn atoms.

A magnetic element according to an application example of the present disclosure includes:
the dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 shows an example of an X-ray diffraction pattern obtained by performing crystal structure analysis using an X-ray diffraction method (XRD) on a soft magnetic powder after a heat treatment.

FIG. 2 is a partially enlarged cross-sectional view showing a dust core according to an embodiment.

FIG. 3 shows a result of elemental mapping analysis performed on a cross section of the dust core using an energy dispersive X-ray fluorescence analyzer (EDX), which is an elemental mapping analysis result focusing on Si.

FIG. 4 shows a result of elemental mapping analysis performed on a cross section of the dust core using an energy dispersive X-ray fluorescence analyzer (EDX), which is an elemental mapping analysis result focusing on Sn.

FIG. 5 is a plan view schematically showing a toroidal type coil component.

FIG. 6 is a transparent perspective view schematically showing a closed magnetic circuit type coil component.

FIG. 7 is a perspective view showing a mobile personal computer which is an electronic device according to the embodiment.

FIG. 8 is a plan view showing a smartphone which is an electronic device according to the embodiment.

FIG. 9 is a perspective view showing a digital still camera which is an electronic device according to the embodiment.

### DESCRIPTION OF EMBODIMENTS

Hereinafter, a soft magnetic powder, a dust core, a magnetic element, and an electronic device of the present disclosure will be described in detail based on a preferred embodiment shown in the accompanying drawings.

### 1. Soft Magnetic Powder

The soft magnetic powder according to the embodiment is a metal powder exhibiting soft magnetism properties. The soft magnetic powder can be applied to various uses, for example, production of various green compacts such as a dust core and an electromagnetic wave absorber by binding particles together with a binder.

### 1.1. Composition

The soft magnetic powder contains Fe (iron) as a main component, Si (silicon) having a content of 2.5 mass % or more and 7.5 mass % or less, Cr (chromium) having a content of 1.0 mass % or more and 10.0 mass % or less, Sn (tin) having a content of 0.05 mass % or more and 1.10 mass % or less, and impurities.

The main component refers to an element having a highest content in terms of an atomic ratio. Fe is a main component of the soft magnetic powder and greatly affects basic magnetic properties of the soft magnetic powder.

The content of Fe is not particularly limited, and is preferably 80 mass % or more, and more preferably 90 mass % or more.

The content of Si is 2.5 mass % or more and 7.5mass % or less, preferably 2.7 mass % or more and 5.0 masss or less, and more preferably 3.0 mass % or more and 4.5 masso or less. When the content of Si is within the above range, a green compact having a higher permeability can be obtained. When the content of Si is less than the lower limit value, magnetic properties such as a permeability and a DC superimposition characteristic decrease. On the other hand, when the content of Si exceeds the upper limit value, the soft magnetic powder is hard, and thus a density of the green compact decreases.

The content of Cr is 1.0 mass % or more and 10.0 mass % or less, preferably 3.0 mass % or more and 6.0 masss or less, and more preferably 4.0 mass % or more and 5.0 mass or less. When the content of Cr is within the above range, oxidation resistance of the soft magnetic powder can be improved. Accordingly, it is possible to obtain a soft magnetic powder in which an oxide proportion at the time of powder pressing is reduced to be particularly low, and with which a green compact having favorable magnetic properties such as the permeability and the DC superimposition characteristic can be produced. When the content of Cr is less than the lower limit value, the oxidation resistance of the soft magnetic powder decreases. On the other hand, when the content of Cr exceeds the upper limit value, the magnetic properties such as the permeability and the DC superimposition characteristic decrease.

The content of Sn is 0.05 mass % or more and 1.10mass % or less, preferably 0.07 mass % or more and 0.80 mass % or less, and more preferably 0.10 mass % or more and 0.40mass % or less. When the content of Sn is within the above range, a particle shape of the soft magnetic powder can be closer to a spherical shape. Accordingly, even when a particle diameter is small, fillability of the soft magnetic powder can be improved, and the density of the green compact can be increased. When the content of Sn is less than the lower limit value, a circularity of the particle shape decreases, and the fillability decreases. Therefore, the density of the green compact decreases, and the magnetic properties such the as permeability and the DC superimposition characteristic decrease. On the other hand, when the content of Sn exceeds the upper limit value, the soft magnetic powder is easily oxidized, and a content of oxygen increases. An oxide generated along with oxidation reduces a metal proportion in the green compact, thus causes a decrease in the density of the green compact, and the magnetic properties such as the permeability and the DC superimposition characteristic decrease.

A mass ratio of a content amount of Sn to a content amount of Cr is Sn/Cr. The mass ratio Sn/Cr is 0.02 or more and 0.30 or less, preferably 0.03 or more and 0.25 or less, and more preferably 0.04 or more and 0.20 or less. When the mass ratio Sn/Cr is within the above range, a balance between the content amount of Cr and the content amount of Sn can be optimized. Accordingly, the fillability can be improved by the particle shape whereas the magnetic properties can be improved by composition optimization. As a result, a green compact having particularly favorable magnetic properties is obtained. When the mass ratio Sn/Cr is within the above range, an amount of Sn-substituted hematite generated along with a heat treatment can be optimized. The Sn-substituted hematite improves insulating properties of the soft magnetic powder after the heat treatment as will be described later. Therefore, it is possible to obtain a soft magnetic powder with which a green compact having a favorable withstand voltage can be produced by subjecting the soft magnetic powder to the heat treatment.

When the mass ratio Sn/Cr is less than the lower limit value, the oxidation resistance of the soft magnetic powder is improved, but the circularity of the particle shape decreases, and the fillability of the soft magnetic powder decreases. In addition, a relative amount of Sn decreases, and the amount of Sn-substituted hematite generated along with the heat treatment decreases. On the other hand, when the mass ratio Sn/Cr is more than the upper limit value, the soft magnetic powder is spherical, but the oxidation resistance decreases, and the metal proportion in the green compact decreases. In addition, the relative amount of Sn is excessive, and the magnetic properties of the soft magnetic powder decrease.

The soft magnetic powder may contain other elements as impurities in addition to the above elements. The impurities refer to elements other than the above elements.

A concentration of the impurities is preferably 0.10 mass % or less, and more preferably 0.05 mass % or less for each element. A total concentration of the impurities is preferably 1.00 mass % or less. Within this range, other elements can be contained without affecting effects of the soft magnetic powder, and thus the impurities are allowed to be contained.

The soft magnetic powder according to the embodiment may contain oxygen as an impurity. Oxygen may be mixed in a raw material or in a production process. A content of oxygen in the soft magnetic powder is preferably 3000 ppm or less, more preferably 2000 ppm or less, and still more preferably 1500 ppm or less in terms of a mass ratio. Accordingly, since deterioration of the particle shape due to adhesion of an oxide to a surface is prevented, a soft magnetic powder having high fillability at the time of powder pressing is obtained. It is also possible to prevent a decrease in a volume fraction of an alloy in the dust core. On the other hand, a lower limit value may not be set, but is preferably 300 ppm or more, and more preferably 500 ppm or more from the viewpoint of ensuring insulating properties between particles. Accordingly, the insulating properties between particles can be sufficiently ensured, and a green compact in which eddy current loss is reduced can be obtained.

The above composition is specified by the following analysis method.

Examples of the analysis method include an iron and steel-atomic absorption spectrometric method defined in JIS G 1257:2000, an iron and steel-ICP emission spectrometric method defined in JIS G 1258:2007, an iron and steel-method for spark discharge atomic emission spectrometric analysis defined in JIS G 1253:2002, an iron and steel-method for x-ray fluorescence spectrometric analysis defined in JIS G 1256:1997, and gravimetric, titration and absorption spectrometric methods defined in JIS G 1211 to JIS G 1237.

Specifically, examples thereof include a solid-state optical emission spectrometer manufactured by SPECTRO, in particular, a spark discharge optical emission spectrometer, model: SPECTROLAB, type: LAVMB08A, and an ICP apparatus type CIROS120 manufactured by Rigaku Corporation.

In particular, when specifying carbon (C) and sulfur(S), an oxygen flow combustion (high-frequency induction furnace combustion)-infrared absorption method defined in JIS G 1211:2011 is also used. Specifically, an example thereof is a carbon and sulfur analyzer CS-200 manufactured by LECO Corporation.

Further, in particular, when nitrogen (N) and oxygen (0) are specified, iron and steel-methods for determination of nitrogen content defined in JIS G 1228:1997 and general rules for determination of oxygen in metallic materials defined in JIS Z 2613:2006 are also used. Specifically, examples thereof include an oxygen and nitrogen analyzer TC-300/EF-300 manufactured by LECO

Corporation, and an oxygen, nitrogen, and hydrogen analyzer ONH836 manufactured by LECO Corporation.

### 1.2. Powder Properties

An average particle diameter of the soft magnetic powder is 1.5 μm or more and 11.0 μm or less, preferably 3.0 μm or more and 10.0 μm or less, and more preferably 4.0 μm or more and 9.0 μm or less. Accordingly, a soft magnetic powder which has high fillability at the time of powder pressing and can reduce eddy current loss in the green compact is obtained.

When the average particle diameter of the soft magnetic powder is less than the lower limit value, the soft magnetic powder is likely to aggregate, the fillability decreases, and the density of the green compact decreases. On the other hand, when the average particle diameter of the soft magnetic powder exceeds the upper limit value, the eddy current loss of the green compact may increase.

The average particle diameter refers to a D50 when a cumulative frequency is 50% from a small diameter side in a cumulative particle size distribution on a volume basis of the soft magnetic powder obtained using a laser diffraction type particle size distribution measuring apparatus.

An average circularity of the soft magnetic powder is preferably 0.80 or more and 0.95 or less, more preferably 0.82 or more and 0.92 or less, and still more preferably 0.85 or more and 0.90 or less. Accordingly, a soft magnetic powder having particularly favorable fillability at the time of powder pressing is obtained. In addition, when an insulating coating film is formed on a particle surface of the soft magnetic powder, the film can be formed uniformly and evenly. Accordingly, it is possible to produce a green compact having excellent insulating properties between particles. In addition, by forming the film uniformly and evenly, a specific surface area can be reduced, and thus an amount of a binder covering a surface can also be reduced. Therefore, since the amount of the binder that binds the particles can be small, the magnetic properties of the green compact can be improved.

When the average circularity is less than the lower limit value, the fillability of the soft magnetic powder at the time of powder pressing may decrease. In addition, uniformity of a film thickness of the insulating coating film may decrease. On the other hand, when the average circularity exceeds the upper limit value, a degree of difficulty in producing the soft magnetic powder may increase.

The average circularity of the soft magnetic powder is measured as follows.

First, an image (secondary electron image) of the soft magnetic powder is captured using a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 or more and 100 or less particles appear in one image. Then, a plurality of images are acquired to obtain images of a total of 300 or more particles.

Next, a circularity of the images of 300 or more particles is calculated using software, and an average value is obtained. The obtained average value is the average circularity of the soft magnetic powder. When a circularity is represented by e, an area of a particle image is represented by S, and a perimeter of the particle image is represented by L, the circularity e is obtained using the following formula.

$$e = 4 π S / {L}^{2}$$

A particle of the soft magnetic powder may contain a plurality of crystal grains. That is, the particle of the soft magnetic powder may contain a polycrystalline structure. The number of crystal grains per unit area in a cross section of the particle is preferably 0.10 [grains/(μm)²] or more and 0.45 [grains/(um)²] or less, more preferably 0.14[grains/(μm)²] or more and 0.38 [grains/(μm)²] or less, and still more preferably 0.16 [grains/(μm)²] or more and 0.35 [grains/(μm)²] or less. When the number of crystal grains per unit area in the cross section of the particle is within the above range, a number density of the crystal grains can be optimized, and as a result, a crystal grain diameter can be optimized. Accordingly, the particle appropriately deforms at the time of powder pressing, and a soft magnetic powder with which a high-density green compact can be produced is obtained. In addition, a soft magnetic powder having a sufficiently high permeability depending on the crystal grain diameter and low eddy current loss is obtained.

The number of crystal grains per unit area in the cross section of the particle of the soft magnetic powder is measured as follows.

First, the cross section of the particle of the soft magnetic powder is etched with a 3% Nital etching solution (3% nitric acid, 97% ethanol). Next, an image of the cross section of the particle is captured using a scanning transmission electron microscope (STEM). Next, the obtained image is read into image processing software. As the image processing software, for example, image analysis type particle size distribution measurement software “Mac-View” manufactured by Mountech Co., Ltd. is used.

Next, an area of the cross section (cross-sectional area) of the particle is calculated. The cross-sectional area is calculated using the following calculation formula after calculating a long diameter and a short diameter of the cross section.

Cross-Sectional Area=Long Diameter×Short Diameter ×π÷4

The image processing software detects crystal grains in the image of the cross section. Next, the number of crystal grains in the cross section of one particle is counted. Then, the counted number of crystal grains is divided by the cross-sectional area to calculate the number of crystal grains per unit area in the cross section (the number density of crystal grains). A unit thereof is grains/(μm)².

### 1.3. Insulating Coating Film

If necessary, an insulating coating film may be provided on the surface of the particle of the soft magnetic powder. By providing such an insulating coating film, the insulating properties between the particles of the soft magnetic powder can be improved. As a result, an eddy current flowing between the particles can be limited, and the eddy current loss in the green compact can be reduced.

Examples of the insulating coating film include a glass material, a ceramic material, and a resin material.

### 1.4. Crystal Structure Analysis Using X-Ray Diffraction Method

When the soft magnetic powder according to the embodiment is subjected to a heat treatment in an air atmosphere and then subjected to crystal structure analysis using an X-ray diffraction method, an obtained X-ray diffraction pattern has a peak originating from Sn-substituted hematite. The Sn-substituted hematite is a compound obtained by substituting a part of Fe atoms forming hematite (an iron oxide represented by Fe₂O₃) by Sn atoms. Even when a content amount of such Sn-substituted hematite is small, the Sn-substituted hematite imparts favorable insulating properties to the soft magnetic powder after the heat treatment. Therefore, using the soft magnetic powder after the heat treatment, a green compact having a high density and an excellent withstand voltage is obtained.

The heat treatment is, for example, a treatment of heating at 600° C. for 1 hour in an air atmosphere.

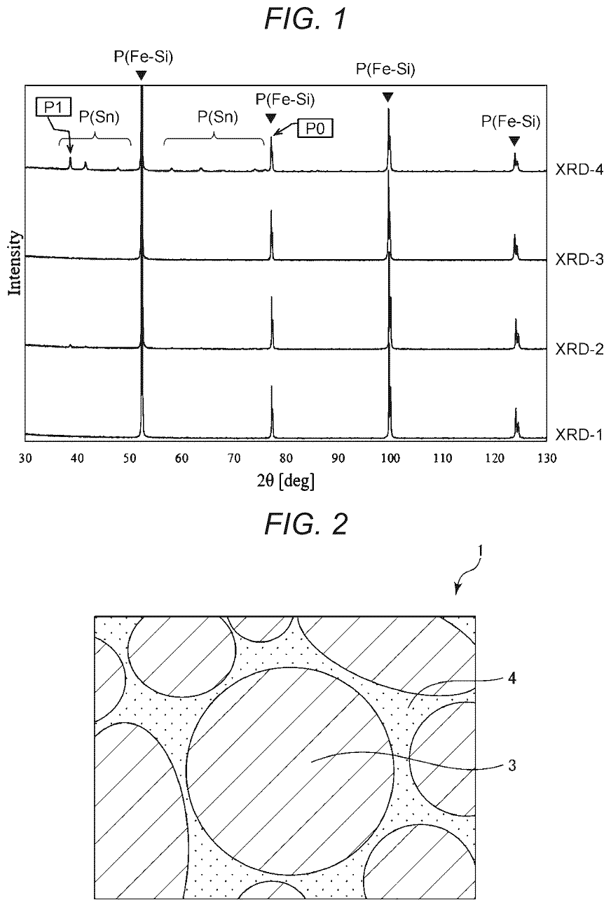

FIG. 1 shows an example of the X-ray diffraction pattern obtained by performing the crystal structure analysis using the X-ray diffraction method (XRD) on the soft magnetic powder after the heat treatment.

FIG. 1 shows four X-ray diffraction patterns XRD-1, XRD-2, XRD-3, and XRD-4.

XRD-1 is an X-ray diffraction pattern obtained before a heat treatment of a soft magnetic powder having a composition of Fe-3.5Si-4.5Cr. In the formula representing the composition, a numerical value before each element symbol represents a mass concentration of each element. A content amount of Fe is a remainder of the other elements.

XRD-2 is an X-ray diffraction pattern obtained after the heat treatment of the soft magnetic powder having the composition of Fe-3.5Si-4.5Cr.

XRD-3 is an X-ray diffraction pattern obtained before a heat treatment of a soft magnetic powder having a composition of Fe-3.5Si-4.5Cr-1.0Sn.

XRD-4 is an X-ray diffraction pattern obtained after the heat treatment of the soft magnetic powder having the composition of Fe-3.5Si-4.5Cr-1.0Sn.

In each of the four X-ray diffraction patterns XRD-1, XRD-2, XRD-3, and XRD-4 shown in FIG. 1, four strong peaks P (Fe-Si) each originating from an Fe-Si alloy crystal are observed. Here, the peak P (Fe-Si) located at 2θ=77°±1°0 is defined as a reference peak P0.

In XRD-4 shown in FIG. 1, in addition to four peaks P (Fe—Si) originating from the Fe—Si alloy crystal, a plurality of peaks P (Sn) scattered in a range of 2θ=35° to 75° are observed. These peaks P(Sn) originate from a crystal structure of the Sn-substituted hematite. Here, the peak P (Sn) located near 2θ=39°±1° is defined as an index peak P1. The index peak P1 is a peak originating from a crystal plane represented by a Miller index (104) of the Sn-substituted hematite.

In XRD-4, when peak top intensity of the reference peak P0 is 1, peak top intensity of the index peak P1 is preferably 0.100 or more and 0.700 or less, more preferably 0.150 or more and 0.600 or less, and still more preferably 0.200 or more and 0.500 or less. When an intensity ratio of the index peak P1 to the reference peak P0 is within the above range, a ratio of the Sn-substituted hematite in n the soft magnetic powder after the heat treatment is optimized. Accordingly, it is possible to obtain a soft magnetic powder with which a green compact having an excellent withstand voltage can be produced without impairing magnetic properties.

When the intensity ratio of the index peak P1 to the reference peak P0 is less than the lower limit value, the ratio of the Sn-substituted hematite in the soft magnetic powder after the heat treatment decreases, and thus the withstand voltage of the green compact may decrease. On the other hand, when the intensity ratio of the index peak P1 to the reference peak P0 exceeds the upper limit value, the Sn-substituted hematite is excessive, and the magnetic properties of the green compact may decrease.

The intensity ratio can be adjusted by the content of Sn and presence or absence of the heat treatment. For example, the intensity ratio can be increased by increasing the content of Sn. The intensity ratio can also be increased by subjecting the soft magnetic powder to the heat treatment.

In the example shown in FIG. 1, no significant peak P (Sn) is observed in XRD-1, XRD-2, or XRD-3.

### 1.5. Tapped Density

A tapped density of the soft magnetic powder is preferably 3.80 g/cm³ or more and 5.10 g/cm³ or less, more preferably 3.90 g/cm³ or more and 5.00 g/cm³ or less, and still more preferably 4.00 g/cm³ or more and 5.00 g/cm³ or less. When the tapped density is within the above range, a soft magnetic powder having particularly favorable fillability is obtained. Accordingly, it is possible to produce a green compact having a higher density. When the tapped density is less than the lower limit value, the fillability of the soft magnetic powder decreases, and the density of the green compact may decrease. On the other hand, when the tapped density exceeds the upper limit value, the degree of difficulty in producing the soft magnetic powder may increase.

The tapped density of the soft magnetic powder is measured as follows.

First, the soft magnetic powder is treated with a coupling agent. Phenyltrimethoxysilane is used as the coupling agent. Next, the tapped density of the treated soft magnetic powder is measured using a powder characteristics evaluation apparatus. As the powder characteristics evaluation apparatus, Powder Tester (registered trademark) PT-X manufactured by Hosokawa Micron Corporation is used.

### 1.6. Specific Surface Area

A specific surface area of the soft magnetic powder is preferably 0.170 m²/g or more and 0.320 m²/g or less, more preferably 0.180 m²/g or more and 0.300 m²/g or less, and still more preferably 0.190 m²/g or more and 0.280 m²/g or less. When the specific surface area is within the above range, the fillability of the soft magnetic powder is improved, and the density of the green compact can be increased. When the specific surface area is less than the lower limit value, a particle diameter of the soft magnetic powder is excessively large, and iron loss of the green compact may increase. On the other hand, when the specific surface area exceeds the upper limit value, the fillability of the soft magnetic powder decreases, and the density of the green compact may decrease.

The specific surface area of the soft magnetic powder is obtained using a BET method. As a specific surface area measuring apparatus, for example, a BET type specific surface area measuring apparatus HM1201-010 manufactured by Mountech Co., Ltd. may be used, and a specimen amount is 5 g.

### 1.7. Coercive Force

The soft magnetic powder according to the embodiment preferably has a coercive force of 12.0 [Oe] or less (955 [A/m] or less), more preferably 10.0 [Oe] or less (796 [A/m] or less), and still more preferably 8.0 [Oe] or less (637 [A/m] or less). When the coercive force is within the above range, hysteresis loss in the green compact can be reduced. From the viewpoint of ease of production of the soft magnetic powder, the coercive force is preferably 2.0 [Oe] or more (159 [A/m] or more), and more preferably 3.0 [Oe] or more (239 [A/m] or more).

The coercive force of the soft magnetic powder may be measured using a vibrating sample magnetometer or the like. A maximum applied magnetic field when measuring the coercive force is, for example, 15 kOe.

### 2. Method for Producing Soft Magnetic Powder

Next, an example of a method for producing the above soft magnetic powder will be described.

The soft I magnetic powder may be a powder produced using any method. Examples of the method for producing the soft magnetic powder include a pulverization method, in addition to various atomization methods such as a water atomization method, a rotary water jet atomization method, and a gas atomization method. Among these, a powder produced by an atomization method is preferably used as the soft magnetic powder. According to the atomization method, it is possible to efficiently produce a high-quality metal powder having a particle shape closer to a perfect sphere with less formation of an oxide or the like. Therefore, a metal powder having a smaller specific surface area can be produced using the atomization method.

The atomization method is a method of producing a metal powder by causing a molten metal to collide with a liquid or a gas ejected at a high speed to atomize and cool the molten metal. In the atomization method, since the molten metal is more spherical in the process of solidification after the molten metal is atomized, a particle closer to a perfect sphere can be produced.

The water atomization method is a method of producing a metal powder from a molten metal by using a liquid such as water as a cooling liquid, spraying the liquid in an inverted conical shape to converge the liquid to one point, and causing the molten metal to flow down toward the convergence point and to undergo collision.

The rotary water jet atomization method is a method of producing a metal powder by supplying a cooling liquid along an inner peripheral surface of a cooling cylinder, swirling the cooling liquid along the inner peripheral surface, spraying a jet of a liquid or a gas to a molten metal, and capturing the scattered molten metal into the cooling liquid.

The gas atomization method is a method of producing a metal powder from a molten metal by using a gas as a cooling medium, injecting the gas in an inverted conical shape that converges the gas to one point, and causing the molten metal to flow down toward the convergence point and undergo collision.

According to such atomization methods, it is possible to adjust the particle diameter and the circularity of the particle of the soft magnetic powder, and the number density of the crystal grains in the cross section of the particle according to conditions thereof.

A casting temperature that is a melting temperature is preferably set, with respect to a melting point Tm [° C.] of a constituent material of the soft magnetic powder, to Tm+200° C. or higher, more preferably Tm+220° C. or higher and Tm+350° C. or lower, and still more preferably Tm+250° C. or higher and Tm+300° C. or lower. Accordingly, since viscosity of the molten metal decreases, a minuter particle can be efficiently produced. It is also possible to ensure a time during which the molten metal is present longer than that in the related art when the molten metal is atomized and solidified using various atomization methods. Accordingly, the circularity of the particle of the soft magnetic powder can be increased, and the number density of the crystal grains in the cross section of the particle can be adjusted within the above range.

In the atomization method, the molten metal is allowed to flow down from a narrow opening, and an obtained fine stream of the molten metal is allowed to collide with a fluid jet. An outer diameter of the fine stream of the molten metal is not particularly limited, and is preferably 2.5 mm or less, more preferably 0.3 mm or more and 2.0 mm or less, and still more preferably 0.5 mm or more and 1.5 mm or less. Accordingly, the fluid jet can be easily and uniformly applied to the molten metal, and thus liquid droplets having an appropriate size can be easily and uniformly scattered. As a result, the average particle diameter and the average circularity of the soft magnetic powder can be adjusted within the above ranges. Since cooling rate is relatively high, the content of oxygen in the soft magnetic powder can be adjusted within the above range. Further, since an amount of the molten metal supplied during a certain period of time is reduced, the cooling rate of each liquid droplet is uniform, and the number density of the crystal grains in the cross section of the particle of the soft magnetic powder can be easily adjusted within the above range.

The produced soft magnetic powder may be classified as necessary. Examples of classification methods include dry classification such as sieving classification, inertial classification, and centrifugal classification, and wet classification such as sedimentation classification.

### 3. Dust Core

Next, the dust core according to the embodiment will be described.

FIG. 2 is a partially enlarged cross-sectional view showing a dust core 1 according to the embodiment. The dust core 1 shown in FIG. 2 contains soft

magnetic particles 3 (particles of the soft magnetic powder according to the embodiment) and a binding portion 4 that binds the soft magnetic particles 3. The binding portion 4 contains an Fe oxide. Since the binding portion 4 containing such an inorganic material is distributed to fill a gap between the soft magnetic particles 3, the dust core 1 has favorable mechanical strength. Since the binding portion 4 is chemically and thermally stable, the dust core 1 has favorable durability and heat resistance.

The dust core 1 shown in FIG. 2 is produced by molding the soft magnetic powder according to the embodiment together with a binder and performing a heat treatment thereon. Along with the heat treatment, the Fe oxide is precipitated from the soft magnetic particles 3, and the binding portion 4 is generated. Accordingly, the soft magnetic particles 3 are strongly bound to each other.

A temperature of the heat treatment is preferably 500° C. or higher and 800° C. or lower, and more preferably 550° C. or higher and 700° C. or lower. When the temperature of the heat treatment is lower than the lower limit value, formation of the binding portion 4 is insufficient, and insulating properties of the dust core 1 may decrease. On the other hand, when the temperature of the heat treatment is higher than the upper limit value, magnetic properties of the soft magnetic particle 3 may decrease.

A time of the heat treatment is preferably 0.5 hours or longer and 10 hours or shorter, and more preferably 1 hour or longer and 3 hours or shorter, as a time during which the temperature is maintained in the above range.

An atmosphere of the heat treatment may be a reducing atmosphere or an inert atmosphere, preferably an oxidizing atmosphere, and more preferably an air atmosphere. Accordingly, the precipitation of the Fe oxide is promoted, and the binding portion 4 can be efficiently generated. Since nitrogen is also contained in the air atmosphere, excessive oxidation can be prevented, and a decrease in the magnetic properties of the soft magnetic powder after the heat treatment can be prevented.

The Fe oxide contains Sn-substituted hematite in which a part of Fe atoms is substituted by Sn atoms. The Sn-substituted hematite imparts favorable insulating properties to the dust core 1 even when a content amount of the Sn-substituted hematite is small. Therefore, the dust core 1 having a high density and an excellent withstand voltage is obtained. The Sn-substituted hematite reduces an eddy current between the soft magnetic particles 3. Accordingly, the dust core 1 having low iron loss is obtained. The Fe oxide may contain elements other than Fe, O, and Sn. In this case, a content of each element is preferably less than each content of Fe, O, and Sn in terms of an atomic ratio.

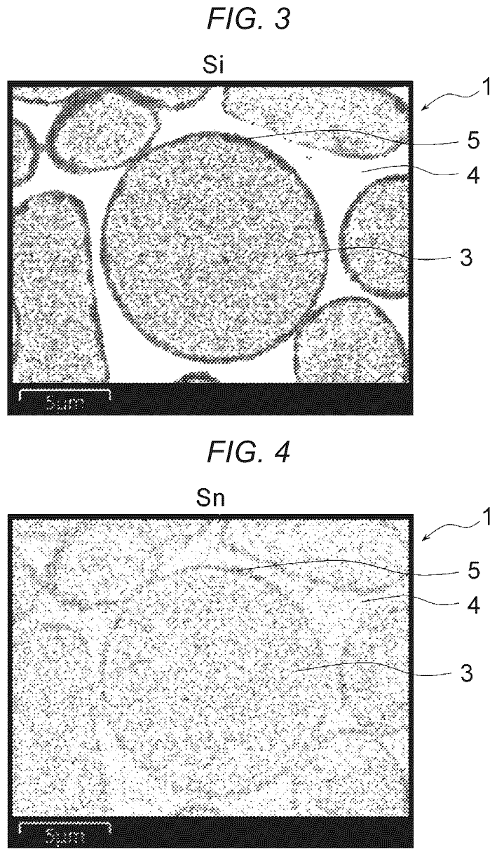

FIGS. 3 and 4 show results of elemental mapping analysis performed on a cross section of the dust core 1 using an energy dispersive X-ray fluorescence analyzer (EDX). FIG. 3 shows an elemental mapping analysis result focusing on Si, and FIG. 4 shows an elemental mapping analysis result focusing on Sn. Concentrations of Si and Sn are represented by color intensity in FIGS. 3 and 4.

As shown in FIGS. 3 and 4, the dust core 1 preferably contains a segregation layer 5 located at a boundary between the soft magnetic particle 3 and the binding portion 4. The segregation layer 5 is a layer in which Si and Sn are segregated. The segregation of Si and Sn refers to a state in which the concentration of Si in the segregation layer 5 is higher than that in both the soft magnetic particle 3 and the binding portion 4, and the concentration of Sn is also higher than that in both the soft magnetic particle 3 and the binding portion 4. By providing such a segregation layer 5, adhesion between the soft magnetic particle 3 and the binding portion 4 can be improved. Accordingly, the mechanical strength of the dust core 1 can be further improved.

FIG. 3 shows a state in which Si is annularly segregated between the soft magnetic particle 3 and the binding portion 4. Similarly, FIG. 4 shows a state in which Sn is annularly segregated between the soft magnetic particle 3 and the binding portion 4. These annular areas correspond to the segregation layer 5.

### 3.1. Crystal Structure Analysis Using X-Ray Diffraction Method

When the dust core 1 is subjected to crystal structure analysis using an X-ray diffraction method, an obtained X-ray diffraction pattern has a peak originating from Sn-substituted hematite.

An example of the X-ray diffraction pattern obtained from the dust core 1 is the X-ray diffraction pattern XRD-4 shown in FIG. 1. In XRD-4, when the peak top intensity of the reference peak P0 is 1, the peak top intensity of the index peak P1 is preferably 0.100 or more and 0.700 or less, more preferably 0.150 or more and 0.600 or less, and still more preferably 0.200 or more and 0.500 or less. When the intensity ratio of the index peak P1 to the reference peak P0 is within the above range, a ratio of the Sn-substituted hematite in the dust core 1 is optimized. Accordingly, it is possible to obtain the dust core 1 having an excellent withstand voltage without impairing magnetic properties.

When the intensity ratio of the index peak P1 to the reference peak P0 is less than the lower limit value, the ratio of the Sn-substituted hematite decreases, and thus the withstand voltage of the dust core 1 may decrease. On the other hand, when the intensity ratio of the index peak P1 to the reference peak P0 exceeds the upper limit value, the Sn-substituted hematite is excessive, and the magnetic properties of the dust core 1 may decrease.

### 3.2. Green Compact Density

A density of the dust core 1 is preferably 5.30 g/cm³ or more and 6.10 g/cm³ or less, and more preferably 5.50 g/cm³ or more and 6.00 g/cm³ or less. Accordingly, the dust core 1 having a high density and excellent magnetic properties is obtained.

### 3.3. Permeability

A permeability of the dust core 1 at a measurement frequency of 1 MHz is preferably 30 or more, and more preferably 32 or more. Accordingly, the dust core 1 whose size is easily reduced is obtained.

The permeability of the dust core 1 is measured as follows.

First, the dust core 1 is formed into an annular shape having an outer diameter of 14 mm, an inner diameter of 8 mm, and a thickness of 3 mm. Next, the obtained dust core 1 is placed in a resin case, and then a conductive wire having a wire diameter of 0.6 mm is wound around the case seven times to prepare a test sample. Next, a permeability of the test sample is measured at a frequency of 1 MHz. For the measurement of the permeability, an impedance analyzer (4194A, manufactured by Keysight Technologies, Inc.) or the like is used.

### 3.4. DC Superimposition Characteristic

The dust core 1 has a high DC superimposition characteristic. A magnetic element using the dust core 1 is often subjected to an application of a direct current superimposed on an AC signal. Therefore, the dust core 1 is required to have a favorable permeability characteristics under a DC magnetic field. In the present specification, when a permeability at the time of an application of a DC magnetic field superimposed on an AC signal decreases by 30% from a permeability when no DC magnetic field is applied, strength of the DC magnetic field at that time is treated as the DC superimposition characteristic. When the DC superimposition characteristic according to this definition is high, a high permeability can be maintained even with a high applied magnetic field. A frequency of the AC signal when the DC superimposition characteristic is measured is 10 KHz.

The DC superimposition characteristic of the dust core 1 is preferably 15000 [A/m] or more, more preferably 16000 [A/m] or more, and still more preferably 17000 [A/m] or more. The dust core 1 having such a DC superimposition characteristic is suitable for a high current application. That is, according to the dust core 1 having such a DC superimposition characteristic, it is possible to obtain a magnetic element having excellent operational stability even when a high current is applied.

The DC superimposition characteristic is evaluated as follows.

First, the dust core 1 is formed into an annular shape having an outer diameter of 14 mm, an inner diameter of 8 mm, and a thickness of 3 mm. Next, the obtained dust core 1 is placed in a resin case, and then a conductive wire having a wire diameter of 1.25 mm is wound around the case fifty times to prepare a test sample. Next, a permeability when an AC signal having a frequency of 10 kHz is applied to the test sample without superimposing a DC bias current is set as a reference value. Next, the permeability is measured while gradually increasing the DC bias current superimposed on the test sample. When a measured value decreases by 30% from the reference value, strength of a magnetic field (strength of a DC magnetic field) under the DC bias current at that time is measured.

### 3.5. Withstand Voltage

When the withstand voltage of the dust core 1 is measured at an inter-electrode distance of 3 mm, the dust core 1 preferably has a withstand voltage of 1000 V or more. When the dust core 1 has such a withstand voltage, the dust core 1 that can implement a magnetic element having a high rated voltage even with a small size is obtained.

The withstand voltage is more preferably 1000 V or more and 5000 V or less, still more preferably 1500 V or more and 4000 V or less, and particularly preferably 2000 V or more and 3000 V or less.

When the withstand voltage of the dust core 1 is lower than the lower limit value, it may be difficult to reduce the size of the magnetic element when the rated voltage is set to be high. On the other hand, the withstand voltage of the dust core 1 may exceed the upper limit value, but in this case, a degree of difficulty in producing the soft magnetic powder increases, which may cause an increase in production cost and a decrease in production yield.

A method for measuring the withstand voltage is as follows.

First, the dust core 1 is crushed in a mortar or the like to obtain a crushed product. The obtained crushed product (0.5 g) is pressed and molded into a cylindrical shape having a height of 5 mm under a pressure of 0.02 MPa (20 kg/cm²) to obtain a molded product. In the press molding, a copper electrode having a thickness of 1 mm is embedded in each of upper and lower surfaces of the cylinder. Next, each electrode is connected to a power supply apparatus, and a DC voltage is applied between the electrodes. An electric resistance value between the electrodes is measured while increasing the voltage in 50 V steps. A voltage when the electric resistance value is reduced to 1 MΩ or less is referred to as the “withstand voltage”.

### 3.6. Radial Crushing Strength

Radial crushing strength of the dust core 1 is preferably 45 MPa or more, more preferably 50 MPa or more and 150 MPa or less, still more preferably 60 MPa or more and 130 MPa or less, and particularly preferably 70 MPa or more and 120 MPa or less. Even when a load such as an impact is applied to the dust core 1 having such radial crushing strength, defects such as chipping and cracking are unlikely to occur.

When the radial crushing strength is lower than the lower limit value, defects such as chipping and cracking may occur when a load such as a strong impact is applied to the dust core 1. On the other hand, the radial crushing strength may exceed the upper limit value, but in this case, a variation in the mechanical strength of the dust core 1 may increase.

A method for measuring the radial crushing strength is as follows.

First, the dust core 1 is formed into an annular shape having an outer diameter of 14 mm, an inner diameter of 8 mm, and a thickness of 3 mm. Next, radial crushing strength of the obtained dust core 1 is measured. A method for measuring the radial crushing strength is a method according to a radial crushing strength test method defined in JIS Z 2507:2000. Specifically, when the radial crushing strength is K, the outer diameter is D, a radial wall thickness (half a difference between the outer diameter and the inner diameter) is t, the thickness is L, and a breaking load is F, the radial crushing strength K is obtained by K=F(D−t)/(Lt²).

### 4. Magnetic Element

Next, a magnetic element according to the embodiment will be described.

The magnetic element according to the embodiment includes the dust core 1. Specific examples of such a magnetic element include a choke coil, an inductor, a noise filter, a reactor, a transformer, a motor, an actuator, an electromagnetic valve, and a generator.

Hereinafter, two types of coil components will be representatively described as examples of the magnetic element.

### 4.1. Toroidal Type

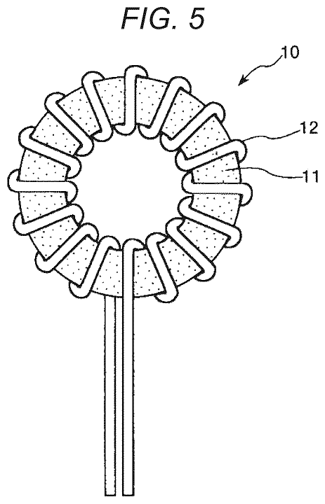

FIG. 5 is a plan view schematically showing a toroidal type coil component 10. The coil component 10 shown in FIG. 5 includes a ring-shaped dust core 11 and a conductive wire 12 wound around the dust core 11. The dust core 1 is used as the dust core 11. Accordingly, it is possible to obtain the dust core 11 having a high density and a high withstand voltage. As a result, it is possible to obtain the coil component 10 which has excellent magnetic properties and to which a high voltage can be applied. When the coil component 10 is mounted on an electronic device or the like, the electronic device or the like can have high performance and a small size.

A shape of the dust core 11 is not limited to the ring shape shown in FIG. 5, and may be, for example, a shape in which a part of the ring is missing, a shape in which a shape in a longitudinal direction is linear, a sheet-like shape, or a film-like shape.

### 4.2. Closed Magnetic Circuit Type

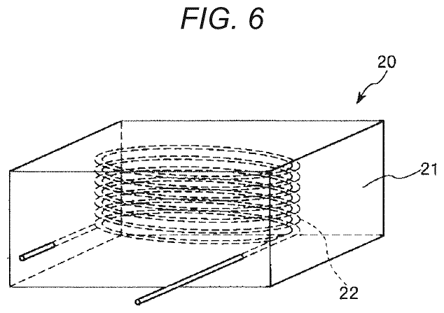

FIG. 6 is a transparent perspective view schematically showing a closed magnetic circuit type coil component 20.

Hereinafter, the closed magnetic circuit type coil component 20 will be described. In the following description, differences from the toroidal type coil component 10 will mainly be described, and description of similar matters will be omitted.

The coil component 20 shown in FIG. 6 is formed by embedding a conductive wire 22 formed in a coil-like shape inside a dust core 21. The dust core 1 is used as the dust core 21. Accordingly, it is possible to obtain the dust core 21 having a high density and a high withstand voltage. As a result, it is possible to obtain the coil component 20 which has excellent magnetic properties and to which a high voltage can be applied.

A shape of the dust core 21 is not limited to the shape shown in FIG. 6, and may be a sheet-like shape, a film-like shape, or the like.

### 5. Electronic Device

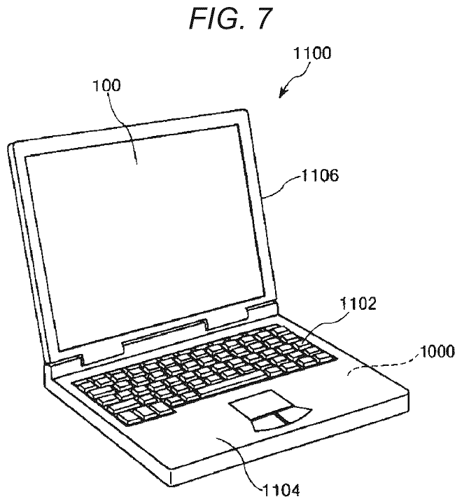

Next, the electronic device including the magnetic element according to the embodiment will described with reference to FIGS. 7 to 9.

FIG. 7 is a perspective view showing a mobile personal computer 1100 which is the electronic device according to the embodiment. The personal computer 1100 shown in FIG. 7 includes a main body 1104 including a keyboard 1102 and a display unit 1106 including a display 100. The display unit 1106 is pivotally supported relative to the main body 1104 via a hinge structure. Such a personal computer 1100 includes therein a magnetic element 1000 such as a choke coil, an inductor, or a motor for a switching power supply.

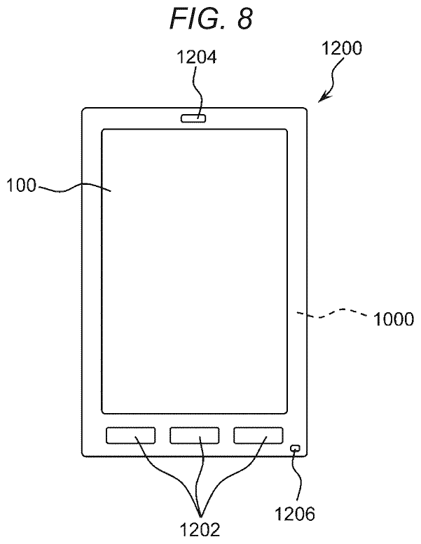

FIG. 8 is a plan view showing a smartphone 1200 which is the electronic device according to the embodiment. The smartphone 1200 shown in FIG. 8 includes a plurality of operation buttons 1202, an earpiece 1204, and a mouthpiece 1206. The display 100 is disposed between the operation buttons 1202 and the earpiece 1204. Such a smartphone 1200 includes therein the magnetic element 1000 such as an inductor, a noise filter, or a motor.

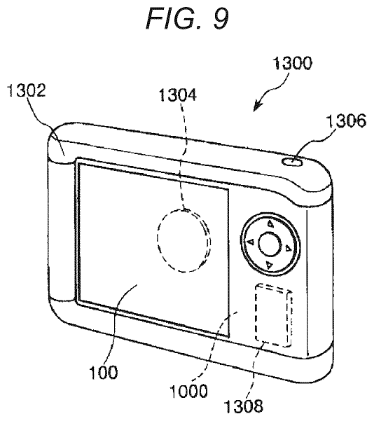

FIG. 9 is a perspective view showing a digital still camera 1300 which is the electronic device according to the embodiment. The digital still camera 1300 photoelectrically converts an optical image of a subject with an imaging element such as a charge coupled device (CCD) to generate an imaging signal.

The digital still camera 1300 shown in FIG. 9 includes the display 100 provided at a rear surface of a case 1302. The display 100 functions as a finder which displays the subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such a digital still camera 1300 also includes therein the magnetic element 1000 such as an inductor or a noise filter.

The dust core 1 is used in the magnetic element 1000. Accordingly, it is possible to obtain the magnetic element 1000 which has excellent magnetic properties and to which a high voltage can be applied. The electronic devices shown in FIGS. 7 to 9 include the magnetic element 1000. Accordingly, effects of the magnetic element 1000 can be provided, and the electronic device can have high performance and a small size.

Examples of the electronic device according to the embodiment include, in addition to the personal computer 1100 in FIG. 7, the smartphone 1200 in FIG. 8, and the digital still camera 1300 in FIG. 9, a mobile phone, a tablet terminal, a watch, inkjet discharge apparatuses such as an inkjet printer, a laptop personal computer, a television, a video camera, a video tape recorder, a car navigation apparatus, a pager, an electronic notebook, an electronic dictionary, a calculator, an electronic game console, a word processor, a workstation, a videophone, a security television monitor, electronic binoculars, a POS terminal, medical devices such as an electronic thermometer, a blood pressure meter, a blood glucose meter, an electrocardiogram measurement apparatus, an ultrasonic diagnostic apparatus, and an electronic endoscope, a fish finder, various measuring devices, instruments for a vehicle, an aircraft, and a ship, vehicle control devices such as an automobile control device, an aircraft control device, a railway vehicle control device, and a ship control device, and a flight simulator.

### 6. Effects of Embodiment

The soft magnetic powder according to the embodiment contains Fe as a main component, Si having a content of 2.5 mass % or more and 7.5 mass % or less, Cr having a content of 1.0 mass % or more and 10.0 mass % or less, Sn having a content of 0.05 mass % or more and 1.10 mass % or less, and impurities. In the soft magnetic powder according to the embodiment, the mass ratio Sn/Cr of the content amount of Sn to the content amount of Cr is 0.02 or more and 0.30 or less, and the average particle diameter is 1.5 μm or more and 11.0 μm or less. Further, the soft magnetic powder according to the embodiment is subjected to the heat treatment in the air atmosphere, thereby precipitating Sn-substituted hematite in which a part of Fe atoms forming hematite is substituted by Sn atoms.

According to such a configuration, the Sn-substituted hematite is precipitated due to the heat treatment in the air atmosphere, and the soft magnetic powder in which particles are bound is obtained. That is, according to the soft magnetic powder, it is possible to produce a dust core which is strong and has excellent insulating properties by being subjected to the heat treatment in the air atmosphere. The dust core has a high density and a high withstand voltage, and thus can implement a magnetic element which has excellent magnetic properties and to which a high voltage can be applied.

In the soft magnetic powder according to the embodiment, the content of Sn is 0.10 mass % or more and 0.60 mass % or less, and the number of crystal grains per unit area in the cross section of the particle is 0.10 [grains/(μm)²] or more and 0.45 [grains/(μm)²] or less.

According to such a configuration, the number density of crystal grains can be optimized, and as a result, the crystal grain diameter can be optimized. Accordingly, the particle appropriately deforms at the time of powder pressing, and a soft magnetic powder with which a high-density dust core can be produced is obtained. In addition, the soft magnetic powder having a sufficiently high permeability depending on the crystal grain diameter and low eddy current loss is obtained.

In the soft magnetic powder according to the embodiment, the content of oxygen is 300 ppm or more and 3000 ppm or less.

According to such a configuration, since deterioration of the particle shape due to adhesion of an oxide to a surface is prevented, the soft magnetic powder having high fillability at the time of powder pressing is obtained. It is also possible to prevent a decrease in a volume fraction of an alloy in the dust core.

The dust core 1 according to the embodiment contains the soft magnetic powder and the binding portion 4 which contains an Fe oxide and binds particles (soft magnetic particles 3) of the soft magnetic powder. The soft magnetic powder contains Fe as a main component, Si having a content of 2.5 mass % or more and 7.5 mass % or less, Cr having a content of 1.0 mass % or more and 10.0 masss or less, Sn having a content of 0.05 mass % or more and 1.10 mass % or less, and impurities, has the mass ratio Sn/Cr of the content amount of Sn to the content amount of Cr of 0.02 or more and 0.30 or less, and has an average particle diameter of 1.5 μm or more and 11.0 μm or less. The Fe oxide contains Sn-substituted hematite in which a part of Fe atoms forming hematite is substituted by Sn atoms.

According to such a configuration, the Sn-substituted hematite imparts favorable insulating properties to the dust core 1. Therefore, the dust core 1 having a high density and an excellent withstand voltage is obtained.

Since the binding portion 4 contains an inorganic material and is distributed to fill a gap between the soft magnetic particles 3, the dust core 1 having favorable mechanical strength is obtained. Since the binding portion 4 is chemically and thermally stable, the dust core 1 having favorable durability and heat resistance is obtained.

In the dust core 1 according to the embodiment, a molded product obtained by molding a crushed product obtained by crushing under a pressure of 49.0 MPa (0.5 t/cm²) has a withstand voltage of 1000 V or more at an inter-electrode distance of 3 mm.

According to such a configuration, the dust core 1 having an excellent withstand voltage is obtained.

When the dust core 1 according to the embodiment is subjected to crystal structure analysis using an X-ray diffraction method, an obtained X-ray diffraction pattern has the reference peak P0 and the index peak P1. The reference peak P0 is located in the range of 2θ=77°±1° and originates from an Fe—Si alloy crystal. The index peak P1 is located in the range of 2θ=39°±1° and originates from the Sn-substituted hematite. When the peak top intensity of the reference peak P0 is 1, the intensity ratio of the index peak P1 is 0.100 or more and 0.700 or less.

According to such a configuration, the ratio of the Sn-substituted hematite in the dust core 1 is optimized. Accordingly, it is possible to obtain the dust core 1 having an excellent withstand voltage without impairing magnetic properties.

In the dust core 1 according to the embodiment, the radial crushing strength measured using the method according to the radial crushing strength test method defined in JIS Z 2507:2000 is 45 MPa or more.

According a configuration, it is possible to obtain the dust core 1 in which defects such as chipping and cracking are unlikely to occur even when a load such as an impact is applied.

The dust core 1 according to the embodiment contains the segregation layer 5. The segregation layer 5 is located at the boundary between the soft magnetic particle 3 (the particle of the soft magnetic powder) and the binding portion 4. In the segregation layer 5, Si and Sn are segregated.

According to such a configuration, it is possible to obtain the dust core 1 in which adhesion between the soft magnetic particle 3 and the binding portion 4 is improved. Accordingly, the mechanical strength of the dust core 1 can be further improved.

The magnetic element according to the embodiment includes the dust core 1 according to the embodiment.

According to such a configuration, it is possible to obtain the magnetic element which has excellent magnetic properties and to which a high voltage can be applied.

The electronic device according to the embodiment includes the magnetic element 1000 according to the embodiment.

According to such a configuration, it is possible to obtain an electronic device having high performance and a small size.

The soft magnetic powder, the dust core, the magnetic element, and the electronic device of the present disclosure are described above based on the preferred embodiment, but the present disclosure is not limited thereto. For example, shapes of the dust core and the magnetic element are not limited to those shown in the drawings, and may be any shapes.

### EXAMPLES

Next, specific examples of the present disclosure will be described.

### 7. Production of Soft Magnetic Powder

### 7.1. Sample No. 1

First, a soft magnetic powder was obtained using a water atomization method. A composition of the obtained soft magnetic powder is as shown in Table 1.

A part of the obtained soft magnetic powder was taken out and subjected to a heat treatment at 600° C. for 1 hour in an air atmosphere. When an X-ray diffraction pattern of the soft magnetic powder subjected to the heat treatment was obtained using XRD, presence of Sn-substituted hematite was confirmed. An XRD intensity ratio (an intensity ratio of the index peak P1 to the reference peak P0) obtained using the above method is shown in Table 1.

Further, for the obtained soft magnetic powder, an average particle diameter, an average circularity, a content of oxygen, and the number of crystal grains per unit area were measured. Measurement results are shown in Table 1.

As production conditions of the soft magnetic powder, a difference between a casting temperature and a melting point, and an outer diameter of a molten metal fine stream are shown in Table 1.

### 7.2. Samples No. 2 to No. 23

Soft magnetic powders were obtained in the same manner as in Sample No. 1 except that compositions of the soft magnetic powders were changed as shown in Tables 1, 2, and 3.

In Tables 1 to 3, among the soft magnetic powders and dust cores prepared using the soft magnetic powders in each Sample No., those corresponding to the present disclosure are denoted as “Examples”, and those not corresponding to the present disclosure are denoted as “Comparative Examples”.

### 8. Evaluation of Soft Magnetic Powder 8.1. Tapped Density of Soft Magnetic Powder

A tapped density of the soft magnetic powder of each Sample No. was measured using the above method. Measurement results are shown in Tables 1 to 3.

### 8.2. Specific Surface Area of Soft Magnetic Powder

A specific surface area of the soft magnetic powder of each Sample No. was measured using the above method. Measurement results are shown in Tables 1 to 3.

### 8.3. Coercive Force of Soft Magnetic Powder

A coercive force of the soft magnetic powder of each Sample No. was measured using the above method. Measurement results are shown in Tables 1 to 3.

### 9. Evaluation of Dust Core

Dust cores were prepared using the soft magnetic powder of each of Examples and Comparative Examples. A preparation method is as follows.

First, the soft magnetic powder and an epoxy resin corresponding to 2.0 mass % of the soft magnetic powder were mixed to obtain a mixture. The obtained mixture was pressed and molded under a pressure of 294.2 MPa (3 t/cm²). Accordingly, two ring-shaped molded products each having an outer diameter of 14 mm, an inner diameter of 8 mm, and a thickness of 3 mm were obtained.

Next, each obtained molded product was subjected to a heat treatment at 600° C. for 1 hour in an air atmosphere. Accordingly, the epoxy resin was removed, and a binding portion was formed to obtain the dust core. One of the two prepared dust cores was cut, and a cross section was observed with a scanning electron microscope to perform elemental mapping analysis. As a result, it was recognized that an Fe oxide was distributed in a gap between soft magnetic particles.

### 9.1. Density

Mass and volume of the dust core of each of Examples and Comparative Examples were measured to calculate a density. Calculation results are shown in Tables 1 to 3.

### 9.2. Radial Crushing Strength

Radial crushing strength of the dust core of each of Examples and Comparative Examples was measured using the above method. Measurement results are shown in Tables 1 to 3.

### 9.3. DC Superimposition Characteristic

A DC superimposition characteristic of the dust core of each of Examples and Comparative Examples was measured using the above method. Measurement results are shown in Tables 1 to 3.

### 9.4. Withstand Voltage

A withstand voltage of the dust core of each of Examples and Comparative Examples was measured using the above method. Measurement results are shown in Tables 1 to 3.

TABLE 1

| | | | | | | | | | | | | Production |
|---|---|---|---|---|---|---|---|---|---|---|---|---|
| | | Configuration of soft magnetic powder | | | | | | | | | | condition |
| | | | | | | | | | | | Number of | Difference |
| | | | | | | | XRD | Average | | Content | crystal | between casting |
| | | Composition | | | | | intensity | particle | Average | of | grains per | temperature and |
| | | Fe | Si | Cr | Sn | Sn/Cr | ratio | diameter | circularity | oxygen | unit area | melting point |
| Sample No. | | mass % | | | | — | — | μm | — | ppm | grains/(μm)² | ° C. |
| No. 1 | Comparative | Remainder | 3. [symbol] | 4. [symbol] | 0.05 | 0.011 | 0.08 | 9.8 | 0.83 | 980 | 0.147 | 260 |
| | Example | | | | | | | | | | | |
| No. 2 | Example | Remainder | 3. [symbol] | 4. [symbol] | 0.10 | 0.022 | 0.12 | 9.5 | 0.85 | 1020 | 0.1 [symbol] 0 | 280 |
| No. 3 | Example | Remainder | 3.5 | 4. [symbol] | 0.20 | 0.044 | 0.21 | 9.4 | 0.8 [symbol] | 1050 | 0.18 [symbol] | 300 |
| No. 4 | Example | Remainder | 3.5 | 4. [symbol] | 0.40 | 0.089 | 0.28 | 8.7 | 0.87 | 1120 | 0.20 [symbol] | 290 |
| No. 5 | Example | Remainder | 3.5 | 4. [symbol] | 0.70 | 0.1 [symbol] 6 | 0.41 | 9.0 | 0.87 | 1320 | 0.245 | 280 |
| No. 6 | Example | Remainder | 3. [symbol] | 4. [symbol] | 1.00 | 0.222 | 0.45 | 8.4 | 0.8 [symbol] | 1700 | 0.281 | 260 |
| No. 7 | Comparative | Remainder | 3. [symbol] | 4. [symbol] | 0.00 | 0.000 | 0.00 | 10.0 | 0.84 | 1080 | 0.134 | 250 |
| | Example | | | | | | | | | | | |
| No. 8 | Comparative | Remainder | 3.0 | 4. [symbol] | 0.02 | 0.004 | 0.00 | 9.9 | 0.84 | 890 | 0.138 | 250 |
| | Example | | | | | | | | | | | |
| No. 9 | Comparative | Remainder | 3. [symbol] | 4. [symbol] | 1.30 | 0.28 [symbol] | 0.80 | 7.8 | 0.89 | 4 [symbol] 00 | 0.410 | 260 |
| | Example | | | | | | | | | | | |

| | | Production | | | | | | | |
|---|---|---|---|---|---|---|---|---|---|
| | | condition | Evaluation result of | | | | | | |
| | | Outer | soft magnetic powder | | | Evaluation result of dust core | | | |
| | | diameter of | | Specific | | | Radial | DC | |
| | | molten metal | Tapped | surface | Coercive | | Cushing | superimposition | Withstand |
| | | fine stream | density | area | force | Density | strength | characteristic | voltage |
| Sample No. | | mm | g/cm [symbol] | m²/g | [symbol] | g/cm [symbol] | MPa | A [symbol] | V |
| No. 1 | Comparative | 1.5 | 4. [symbol] 0 | 0.100 | 6.5 | [symbol] .88 | 44 | 15 [symbol] 00 | 900 |
| | Example | | | | | | | | |
| No. 2 | Example | 1.5 | 4.82 | 0.1 [symbol] 3 | 6.6 | 5.90 | [symbol] 5 | 17500 | 1450 |
| No. 3 | Example | 1.5 | 4.92 | 0.19 [symbol] | [symbol] .4 | 5.93 | 74 | 18000 | 2000 |
| No. 4 | Example | 1.5 | 4.83 | 0.250 | [symbol] .7 | 5.91 | 80 | 19000 | 2100 |
| No. 5 | Example | 1.5 | 4.84 | 0.265 | 6.7 | 5.92 | 86 | 20000 | 2300 |
| No. 6 | Example | 1.5 | 4.8 [symbol] | 0.280 | 6.8 | [symbol] .93 | 90 | 21000 | 2750 |
| No. 7 | Comparative | 1.5 | 4.75 | 0.171 | 6.3 | [symbol] .53 | 38 | 13500 | 950 |
| | Example | | | | | | | | |
| No. 8 | Comparative | 1.5 | 4.7 [symbol] | 0.182 | 6.4 | [symbol] .55 | 42 | 14000 | 1000 |
| | Example | | | | | | | | |
| No. 9 | Comparative | 1.5 | 4.93 | 0.330 | 7.4 | [symbol] .29 | 95 | 22 [symbol] 00 | 1450 |
| | Example | | | | | | | | |

[symbol]

indicates data missing or illegible when filed

TABLE 2

| | | | | | | | | | | | | Production |
|---|---|---|---|---|---|---|---|---|---|---|---|---|
| | | Configuration of soft magnetic powder | | | | | | | | | | condition |
| | | | | | | | | | | | Number of | Difference |
| | | | | | | | XRD | Average | | Content | crystal | between casting |
| | | Composition | | | | | intensity | particle | Average | of | grains per | temperature and |
| | | Fe | Si | Cr | Sn | Sn/Cr | ratio | diameter | circularity | oxygen | unit area | melting point |
| Sample No. | | mass % | | | | — | — | μm | — | ppm | grains/(μm)² | ° C. |
| No. 10 | Example | Remainder | 3. [symbol] | 4.5 | 0.15 | 0.033 | 0.1 [symbol] | 2.2 | 0.85 | 2 [symbol] 00 | 0.172 | 340 |
| No. 11 | Example | Remainder | 3. [symbol] | 4.5 | 0.54 | 0.120 | 0.3 [symbol] | 5. [symbol] | 0. [symbol] 8 | 2000 | 0.220 | 290 |
| No. 12 | Example | Remainder | 3. [symbol] | 1.5 | 0.15 | 0.100 | 0.31 | 2.8 | 0.81 | 2400 | 0.210 | 260 |
| No. 13 | Example | Remainder | 3. [symbol] | 1.5 | 0.40 | 0.267 | 0. [symbol] 4 | 4.3 | 0.83 | 2100 | 0.345 | 210 |
| No. 14 | Comparative | Remainder | 3. [symbol] | 4.5 | 0.20 | 0.044 | 0.2 [symbol] | 1.2 | 0. [symbol] 0 | 3540 | 0.230 | 270 |
| | Example | | | | | | | | | | | |
| No. 15 | Comparative | Remainder | 3.0 | 4.5 | 0.20 | 0.044 | 0.24 | 11.5 | 0. [symbol] | 1100 | 0.156 | 260 |
| | Example | | | | | | | | | | | |
| No. 16 | Comparative | Remainder | 3. [symbol] | 1.5 | 0. [symbol] 0 | 0.333 | 0.7 [symbol] | 2. [symbol] | 0.81 | 2100 | 0.1 [symbol] 8 | 280 |
| | Example | | | | | | | | | | | |

| | | Production | | | | | | | |
|---|---|---|---|---|---|---|---|---|---|
| | | condition | Evaluation result of | | | | | | |
| | | Outer | soft magnetic powder | | | Evaluation result of dust core | | | |
| | | diameter of | | Specific | | | Radial | DC | |
| | | molten metal | Tapped | surface | Coercive | | Cushing | superimposition | Withstand |
| | | fine stream | density | area | force | Density | strength | characteristic | voltage |
| Sample No. | | mm | g/cm [symbol] | m²/g | [symbol] | g/cm [symbol] | MPa | A [symbol] | V |
| No. 10 | Example | 1.0 | 4.10 | 0.3 [symbol] 5 | 7.8 | [symbol] .58 | 68 | 18000 | 1 [symbol] 50 |
| No. 11 | Example | 1.0 | 4.21 | 0.285 | 6.8 | [symbol] .78 | 85 | 19500 | 2400 |
| No. 12 | Example | 1.0 | 4.23 | 0.304 | 7.5 | 5. [symbol] 4 | 65 | 18500 | 2200 |
| No. 13 | Example | 1.0 | 4.25 | 0.294 | 7.0 | 5.74 | 81 | 19000 | 3300 |
| No. 14 | Comparative | 0.5 | 3.25 | 0.453 | 8.5 | 4. [symbol] 0 | 70 | 12500 | 4 [symbol] 00 |
| | Example | | | | | | | | |
| No. 15 | Comparative | 2.5 | 4.36 | 0.245 | 6. [symbol] | [symbol] .89 | 71 | 1 [symbol] 000 | 950 |
| | Example | | | | | | | | |
| No. 16 | Comparative | 1.0 | 3.73 | 0.305 | 7. [symbol] | [symbol] .34 | 8 [symbol] | 13 [symbol] 00 | 900 |
| | Example | | | | | | | | |

[symbol]

indicates data missing or illegible when filed

TABLE 3

| | | | | | | | | | | | | Production |
|---|---|---|---|---|---|---|---|---|---|---|---|---|
| | | Configuration of soft magnetic powder | | | | | | | | | | condition |
| | | | | | | | | | | | Number of | Difference |
| | | | | | | | XRD | Average | | Content | crystal | between casting |
| | | Composition | | | | | intensity | particle | Average | of | grains per | temperature and |
| | | Fe | Si | Cr | Sn | Sn/Cr | ratio | diameter | circularity | oxygen | unit area | melting point |
| Sample No. | | mass % | | | | — | — | μm | — | ppm | grains/(μm)² | ° C. |
| No. 17 | Example | Remainder | 2. [symbol] | 4.5 | 0.20 | 0.044 | 0.2 [symbol] | 8.4 | 0.8 [symbol] | 1080 | 0.184 | 310 |
| No. 1 [symbol] | Example | Remainder | [symbol] .0 | 4.5 | 0.20 | 0.044 | 0.24 | [symbol] .2 | 0.82 | 1200 | 0.203 | 3 [symbol] 0 |
| No. 19 | Example | Remainder | 7.0 | 4.5 | 0.20 | 0.04 [symbol] | 0.2 [symbol] | 7. [symbol] | 0.82 | 1200 | 0.221 | 3 [symbol] 0 |
| No. 20 | Example | Remainder | 3.5 | 1.5 | 0.20 | 0.1 [symbol] 3 | 0.37 | 8.2 | 0.84 | 1100 | 0.210 | 3 [symbol] 0 |
| No. 21 | Example | Remainder | 3. [symbol] | 2.5 | 0.20 | 0.080 | 0.28 | [symbol] . [symbol] | 0.81 | 1220 | 0.207 | 2 [symbol] 0 |
| No. 22 | Example | Remainder | 3. [symbol] | [symbol] .5 | 0.20 | 0.031 | 0.17 | 5.6 | 0.85 | 1100 | 0.170 | 2 [symbol] 0 |
| No. 23 | Example | Remainder | 3. [symbol] | 8.5 | 0.20 | 0.024 | 0.12 | [symbol] .0 | 0.8 [symbol] | 1080 | 0.162 | 2 [symbol] 0 |

| | | Production | | | | | | | |
|---|---|---|---|---|---|---|---|---|---|
| | | condition | Evaluation result of | | | | | | |
| | | Outer | soft magnetic powder | | | Evaluation result of dust core | | | |
| | | diameter of | | Specific | | | Radial | DC | |
| | | molten metal | Tapped | surface | Coercive | | Cushing | superimposition | Withstand |
| | | fine stream | density | area | force | Density | strength | characteristic | voltage |
| Sample No. | | mm | g/cm [symbol] | m²/g | [symbol] | g/cm [symbol] | MPa | A [symbol] | V |
| No. 17 | Example | 1.0 | 4.62 | 0.195 | 6.8 | 5. [symbol] 0 | 70 | 17000 | 2500 |
| No. 1 [symbol] | Example | 1.0 | 4.60 | 0.1 [symbol] 2 | 6.9 | 5.88 | 72 | 16500 | 25 [symbol] 0 |
| No. 19 | Example | 1.0 | 4.60 | 0.1 [symbol] 1 | 7.0 | 5.88 | 68 | 16500 | 2 [symbol] 00 |
| No. 20 | Example | 1.0 | 4.58 | 0.1 [symbol] | 6.8 | 5.8 [symbol] | 6 [symbol] | 1 [symbol] 000 | 1950 |
| No. 21 | Example | 1.0 | 4.57 | 0.1 [symbol] 8 | 7.0 | 5.85 | 72 | 16 [symbol] 00 | 2000 |
| No. 22 | Example | 1.0 | 4.62 | 0.195 | 7.4 | 5.90 | 58 | 17 [symbol] 00 | 2600 |
| No. 23 | Example | 1.0 | 4.64 | 0.198 | 7. [symbol] | 5.92 | 4 [symbol] | 18000 | 3150 |

[symbol]

indicates data missing or illegible when filed

As shown in Tables 1 to 3, it was recognized that the soft magnetic powder of each Example had a high tapped density and a small specific surface area even when a particle diameter was small, and thus had high fillability. It was also recognized that the soft magnetic powder of each Example had a relatively low coercive force. Further, it was recognized that a high-density dust core was obtained using the soft magnetic powder of each Example. Further, it was recognized that this dust core had a high DC superimposition characteristic. It was also possible to increase the withstand voltage of the dust core by optimizing the composition, the particle diameter, and the crystal grain density in the particle cross section of the soft magnetic powder.

What is claimed is:

1. A soft magnetic powder comprising:
Fe as a main component;
Si having a content of 2.5 mass % or more and 7.5 mass % or less;
Cr having a content of 1.0 mass % or more and 10.0 mass % or less;
Sn having a content of 0.05 mass % or more and 1.10 mass % or less; and
an impurity, wherein
a mass ratio Sn/Cr of a content amount of Sn to a content amount of Cr is 0.02 or more and 0.30 or less,
an average particle diameter is 1.5 μm or more and 11.0 μm or less, and
Sn-substituted hematite in which a part of Fe atoms forming hematite is substituted by Sn atoms is precipitated by a heat treatment in an air atmosphere.

2. The soft magnetic powder according to claim 1, wherein the content of Sn is 0.10 mass % or more and 0.60 mass % or less, and a number of crystal grains per unit area in a cross section of a particle is 0.10 [grains/(μm)²] or more and 0.45 [grains/(μm)²] or less.

3. The soft magnetic powder according to claim 1, wherein
a content of oxygen is 300 ppm or more and 3000 ppm or less.

4. A dust core comprising:
a soft magnetic powder which contains Fe as a main component, Si having a content of 2.5 mass % or more and 7.5 mass % or less, Cr having a content of 1.0 mass % or more and 10.0 mass % or less, Sn having a content of 0.05 mass or more and 1.10 mass % or less, and an impurity, in which a mass ratio Sn/Cr of a content amount of Sn to a content amount of Cr is 0.02 or more and 0.30 or less, and which has an average particle diameter of 1.5 μm or more and 11.0 μm or less; and
a binding portion which is made of an Fe oxide and binds particles of the soft magnetic powder, wherein
the Fe oxide contains Sn-substituted hematite in which a part of Fe atoms forming hematite is substituted by Sn atoms.

5. The dust core according to claim 4, wherein a molded product obtained by molding a crushed product, which is obtained by crushing the dust core, under a pressure of 49.0 MPa (0.5 t/cm²) has a withstand voltage of 1000 V or more at an inter-electrode distance of 3 mm.

6. The dust core according to claim 4, wherein when the dust core is subjected to crystal structure analysis using an X-ray diffraction method, an obtained X-ray diffraction pattern has
a reference peak located in a range of 2θ=77°±1° and originating from a crystal of an Fe-Si alloy, and
an index peak located in a range of 2θ=39°±1° and originating from the Sn-substituted hematite, and
when peak top intensity of the reference peak is 1, an intensity ratio of the index peak is 0.100 or more and 0.700 or less.

7. The dust core according to claim 4, wherein
radial crushing strength measured using a method according to a radial crushing strength test method defined in JIS Z 2507:2000 is 45 MPa or more.

8. The dust core according to claim 4, further comprising:
a segregation layer which is located at a boundary between the particle of the soft magnetic powder and the binding portion and in which Si and Sn are segregated.

9. A magnetic element comprising:
the dust core according to claim 4.

10. An electronic device comprising:
the magnetic element according to claim 9.
